(19) United States
(12) Patent Application Publication
(10) Pub. No.: US 2013/0109406 A1
(43) Pub. Date: May 2, 2013

(54) COMMISSIONING SYSTEM FOR SMART BUILDINGS

(71) Applicant: QUALCOMM Incorporated, San Diego, CA (US)

(72) Inventors: James Chester MEADOR, Berkeley, CA (US); Jonathan Charles GRIFFITHS, Fremont, CA (US); Gaurav SETHI, San Ramon, CA (US); David William BURNS, San Jose, CA (US); Philip Don FLOYD, Redwood City, CA (US)

(73) Assignee: QUALCOMM INCORPORATED, San Diego, CA (US)

(21) Appl. No.: 13/661,341

(22) Filed: Oct. 26, 2012

Related U.S. Application Data
(60) Provisional application No. 61/552,811, filed on Oct. 28, 2011.

(51) Int. Cl. H04W 24/00

(52) U.S. Cl. 455/456.1

(57) ABSTRACT

Techniques disclosed herein provide for utilizing network nodes in a building automation system (BAS) that provide a low cost, highly-accurate positioning system. During a commissioning process, nodes can be used to automatically determine a location of other nodes within the building, and the other nodes can be automatically associated with certain sensors and/or controls, based on their locations and attributes. Additional information may be exchanged between the other nodes and other elements of the BAS during the commissioning process. Ranging techniques can be used to locate and/or track nodes, allowing assets and people to be accurately located within the building.

### CROSS-REFERENCE TO RELATED APPLICATION

The present application claims priority to U.S. Provisional Application No. 61/552,811 filed Oct. 28, 2011, and titled “Indoor Positioning System for Smart Buildings,” which is incorporated by reference in its entirety for all purposes.

### BACKGROUND

New buildings often have some level of Building Automation System (BAS) to control lighting, ventilation, safety, and security systems. These systems can be combined with advanced sensor networks and more sophisticated control strategies to improve efficiency. For example, a BAS can utilize sensors to detect light levels throughout the building and utilize the control systems to adjust the lights accordingly. The location of specific sensors and/or other networked components (i.e., “nodes”) can be particularly important in certain applications, but current wireless technologies can make it difficult to accurately locate nodes. GPS, for instance, typically does not work indoors, and WiFi does not achieve high location accuracy (often having an accuracy of 3-5 meters or larger). Proprietary wireless solutions can provide accurate location information, but can be quite costly.

### SUMMARY

Embodiments of the present invention provide utilizing network nodes in a BAS that provide a low cost, highly-accurate positioning system. During an initialization sequence, also known as “commissioning,” a location of one or more nodes can automatically be determined with respect to other nodes within or associated with the building. For example, nodes can use ranging techniques to locate other nodes, allowing fixed and mobile nodes, fixed and mobile assets and structures, and people to be accurately located within any room in a building or within an area associated with the building.

An embodiment of a network comprising a plurality of communicatively-connected components configured for indoor positioning can include a first node having a wireless interface and being disposed at a first location known to the network, and a second node having a wireless interface and being disposed at a second location known to the network. The first node and the second node can be configured to obtain ranging measurements indicating respective distances to a third node. One or more elements in the network can be configured to determine a location of the third node based, at least in part, on the ranging measurements, and automatically commission the third node by associating the third node with one or more components of the network based, at least in part, on the determined location of the third node.

The embodiment of the network comprising the plurality of communicatively-connected components configured for indoor positioning can include one or more of the following features. The one or more elements in the network can be further configured to communicate control information for controlling a status of at least a portion of a structure to the third node. The one or more elements in the network can be further configured to receive sensor information regarding a status of at least a portion of a structure from the third node. The sensor information can include information regarding at least one of lighting, temperature, humidity, movement, occupancy level, or a location associated with an area proximate to the third node. The network further can comprise a control system. The third node can be a mobile node. The first node and the second node can be fixed nodes. The network can be configured to cause either or both of a distributed control system or a positioning system to generate a message based on the determined location of the mobile node. The network can be configured to track movement of the mobile node. The one or more components to which the third node is associated can include one or more of a sensor, a control, an actuator, or a separate node.

Additionally or alternatively, the embodiment of the network comprising the plurality of communicatively-connected components configured for indoor positioning also can include one or more of the following features. The first node and the second node are configured to obtain the ranging measurements by using at least one of the following ranging operations: received signal strength indicator (RSSI), time of flight (TOF), or round trip time (RTT). The network further can be configured to cause a status of at least a portion of a structure to be altered, based on the determined location of the third node. The status can be indicative of at least one of: a power supply, a state of use, a state of one or more controls, a state of one or more interfaces, or one or more sensor readings. The first location and the second location can be physical locations within a structure. The network further can be configured to develop a map of a structure based, at least in part, on known locations of at least one of the first node, the second node, or the third node. The one or more elements in the network further can be configured to automatically commission the third node based on at least one attribute of the third node. The at least one attribute can be related to at least one of the third node's power supply, mobility, communication type, controllable parameters, sensing capabilities, supported protocols for communication, supported frequency bands, equipment identification number (EIN), ranging capabilities, support of asymmetric ranging operations, product information, or supported configurable parameters. The one or more elements can be configured to transmit configuration parameters to the third node based on the at least one attribute.

An embodiment of a method for commissioning a node using a network of communicatively-connected components can include obtaining ranging measurements from a first node and a second node indicating respective distances to a third node where each of the first node, the second node, and the third node use a respective wireless interface to obtain the ranging measurements, and locations of the first node and the second node are known. The method can also include determining a location of the third node based, at least in part, on the ranging measurements, and automatically commissioning the third node by associating the third node with one or more components of the network based, at least in part, on the determined location of the third node.

The embodiment of the method for commissioning a node using a network of communicatively-connected components can also include one or more of the following steps and/or features. The method can include communicating, with at least one of the first node, the second node, or the third node, sensor information regarding a status of at least a portion of a structure; and control information for controlling the status of the at least the portion of the structure. The third node can be a mobile node. The first node and the second node can be fixed nodes. The method can include tracking movement of the mobile node. The method can include causing a status of at least a portion of a structure to be altered, based on the determined location of the third node.

An embodiment of a system for commissioning a node using a network of communicatively-connected components can include means for obtaining ranging measurements from a first node and a second node indicating respective distances to a third node, where each of the first node, the second node, and the third node use a respective wireless interface to obtain the ranging measurements, and locations of the first node and the second node are known. The system can also include means for determining a location of the third node based, at least in part, on the ranging measurements, and means for automatically commissioning the third node by associating the third node with one or more components of the network based, at least in part, on the determined location of the third node.

The embodiment of the system for commissioning a node using a network of communicatively-connected components can also include one or more of the following features. Means for communicating, with at least one of the first node, the second node, or the third node sensor information regarding a status of at least a portion of a structure, and control information for controlling the status of the at least the portion of the structure. The third node can be a mobile node. The first node and the second node can be fixed nodes. Means for tracking movement of the mobile node. Means for causing a status of at least a portion of a structure to be altered, based on the determined location of the third node.

An embodiment of a computer-readable storage medium can be encoded with instructions that, when executed, operate to cause a computer to perform operations comprising receiving ranging measurements from a first node and a second node indicating respective distances to a third node, where each of the first node, the second node, and the third node use a respective wireless interface to obtain the ranging measurements, and locations of the first node and the second node are known. The operations can also comprise determining a location of the third node based, at least in part, on the ranging measurements, and automatically commissioning the third node by associating the third node with one or more components of a network based, at least in part, on the determined location of the third node.

Another embodiment of a method for commissioning a node in an indoor positioning network can include exchanging, using a wireless interface of the node, ranging communications with at least two other nodes for determining a position of the node relative to a structure or map, and sending, using the wireless interface of the node, information regarding the node. The method can also include receiving, using the wireless interface of the node, commissioning information relating to the node, and configuring at least one attribute of the node based on the commissioning information.

The embodiment of the method for commissioning a node in an indoor positioning network also can include one or more of the following features. The information regarding the node can be indicative of a functionality of the node. Sending, using the wireless interface of the node, one or both of sensor information regarding a status of at least a portion of the structure, or control information for controlling the status of the at least the portion of the structure. The node can be a mobile node, and the commissioning information can be based at least in part on the position and the information regarding the node.

Embodiments may include an apparatus comprising an interface configured to couple to a building automation system (BAS), a transceiver configured for wireless ultra-wideband (UWB) communications, and a processor configured to perform ranging to one or more nodes using the UWB communications. The apparatus may comprise or be integrated into a lighting fixture. The lighting fixture may comprise a housing including an illumination element. The lighting fixture may comprise a switch or lighting controller. The apparatus may comprise one or more sensors, for example a temperature sensor or an ambient light sensor. The interface may be configured to receive control information from the BAS. The interface may be configured to send data to the BAS. The apparatus may be configured to determine a location of the one or more other nodes based on the ranging. Further, the apparatus may be configured to determine its own location during a commissioning process based on the ranging. The interface may be configured to transmit one or more characteristics or attributes of the apparatus to the BAS during the commissioning process. The transceiver may be configured to receive a range request packet from a node that is performing ranging with the one or more nodes, and the processor may be configured to perform the ranging based on the received range request and a response received from the one or more nodes. The interface may be configured to transmit information regarding the ranging to a processor or controller of the BAS to determine a location of the one or more nodes.

Items and/or techniques described herein may provide one or more of the following capabilities, as well as other capabilities not mentioned. Techniques can provide for increased accuracy of node location information and decreased cost when compared with other positioning systems. Techniques can also utilize smart commissioning capabilities and power-sensitive ranging techniques to facilitate installation and to reduce power usage on mobile nodes. These and other embodiments, along with many of its advantages and features, are described in more detail in conjunction with the text below and the attached figures.

### BRIEF DESCRIPTION OF THE DRAWINGS

FIG. 1 is a simplified block diagram of a system for indoor positioning in smart buildings, according to one embodiment.

FIG. 2 is a simplified block diagram of an embodiment of a fixed node.

FIG. 3 is a simplified block diagram of an embodiment of a mobile node.

FIG. 4 is a simplified block diagram of a system level view of an indoor positioning system platform.

FIG. 5 is a simplified block diagram of a system having multiple wireless networks.

FIGS. 6 and 7 are simplified flow diagrams illustrating embodiments of methods for commissioning a node using a network of communicatively-connected components.

FIG. 8 is a simplified flow diagram of an embodiment of a method for commissioning a node in a positioning network.

FIG. 9 illustrates an embodiment of a computer system that can be used in the embodiments provided herein.

### DETAILED DESCRIPTION

The following description is provided with reference to the drawings, where like reference numerals are used to refer to like elements throughout. While various details of one or more techniques are described herein, other techniques are also possible. In some instances, structures and devices are shown in block diagram form in order to facilitate describing various techniques.

Buildings consume around 30% of worldwide energy, and in recent years, there has been increasing interest in using technology to improve building efficiency. The term “smart building” refers to a building that uses advanced automation strategies and technology to achieve this end. Solutions which create the greatest synergies between energy efficiency, comfort, safety, and security may be the only sustainable solutions over the long term. Such solutions create buildings that are networked, intelligent, sensitive, and adaptable.

Buildings typically have some level of Building Automation System (BAS). The BAS is installed or retrofitted into a building in order to control the physical plant of the building, including some or all of lighting, ventilation, safety, and security systems. A simple building might have very basic thermostats for heating, ventilation, and air conditioning (HVAC) control and wall switches to control lighting. Smart buildings typically combine more advanced sensing networks and more sophisticated control strategies. For instance, lighting systems with advanced controls can react to occupancy, daylight levels, user preferences, sophisticated schedules, and utility demand reduction requests. Ongoing improvements in the efficiency of lighting systems, particularly in the area of solid state (LED-based) lighting, are leading to widespread deployments of new, more efficient technology. Because LEDs are much easier to control than existing lighting technologies like fluorescent or high intensity discharge lighting, new lighting installations are much more likely to incorporate advanced controls.

Sophisticated controls typically require a much greater level of networking and communication among the elements of the BAS, and automation systems may use wireless technology. Wireless technology has the advantage that it is much faster and cheaper to install, particularly in retrofit situations, such that the cost savings of the installation can compensate for the higher cost of the wireless radio element. Wireless technology also offers flexibility so that the control system can adapt to changes in the way the interior space is configured and used over the life of the building.

BASs may therefore incorporate very dense low-power wireless communication systems and self-forming wireless mesh sensor networks for sensing and control of the building's physical plant. According to embodiments of the invention, such BASs can be configured to incorporate advanced indoor positioning systems that can provide both high accuracy and low cost.

GPS (global positioning system) generally fails to provide sufficient signal strength and accuracy for tracking and locating positions indoors. Existing indoor positioning systems that can achieve high accuracy typically employ proprietary technology that is expensive to install. Existing low cost indoor solutions, such as those based on WiFi, do not achieve high accuracy, often having an accuracy of 3 to 5 meters or larger. Services, systems, and applications that rely on accurate indoor positioning information are therefore not useful or practical.

Embodiments of the present invention provide for enhancing BASs by utilizing network nodes that provide highly-accurate positioning information with little or no additional cost. Such positioning information can enable a BAS to provide enhanced functionality not achievable through other positioning methods. For example, according to certain embodiments, a plurality of fixed-position ultra-wideband (UWB) radio nodes are combined with the infrastructure of a wireless and/or wired BAS, resulting in a system that is capable of determining intra-node distances with an accuracy of one foot or less. In some embodiments, an element or device may be located to within several centimeters or less. During an initialization sequence known as a “commissioning” process, nodes with known positions can be used to automatically determine a location of other nodes within the building. Ranging techniques may be used to locate and/or track nodes, such as fixed nodes (e.g., nodes on items that are not intended to be moved), semi-fixed nodes (e.g., nodes on rarely-moved items or items that are transported only after remaining in a location for a threshold amount of time), and mobile nodes (e.g., nodes on frequently-moved items or on items configured for easy transport), allowing assets and people to be accurately located within any room in a building. Mobile nodes can be included, for example, in personal cell phones, identification badges, or equipment tags. Additional information may be exchanged between one or more nodes and other elements of the BAS during the commissioning process. Advanced applications that use the location information of the semi-fixed and mobile nodes can be developed that provide automation, convenience, and high value to users of the system. The location information may be determined and/or tracking may be performed at any time in some embodiments. For example, the location information for a node may be determined at a time that is not associated with a commissioning process in some embodiments.

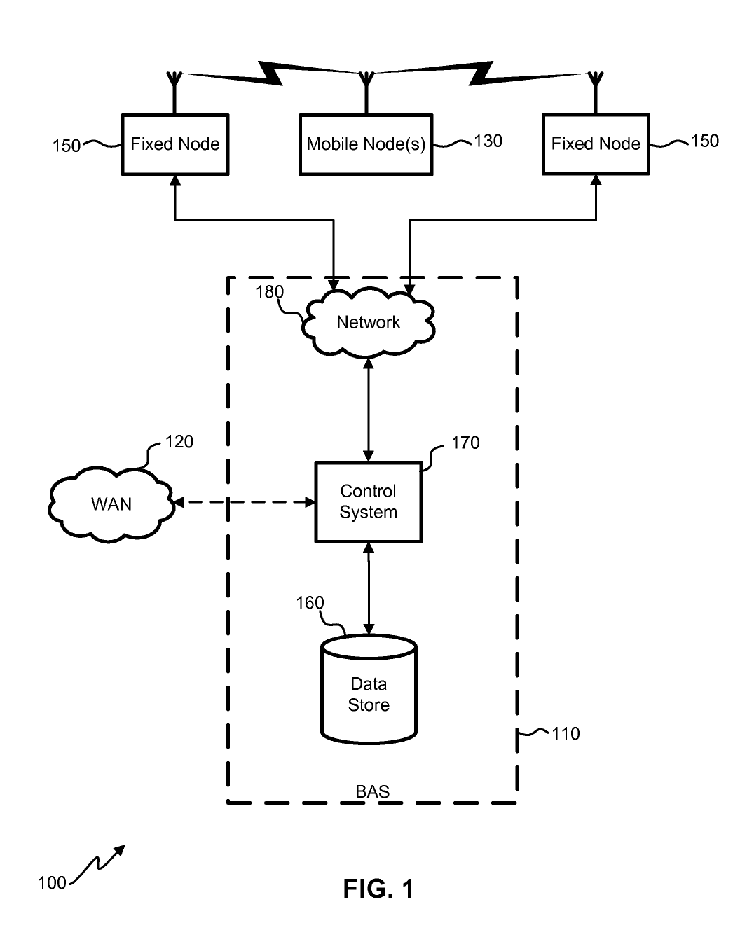

FIG. 1 is a simplified block diagram of a system 100 for indoor positioning in smart buildings, according to one embodiment. The system 100 comprises a BAS 110, with additional components to provide indoor positioning functionality. In this embodiment, the BAS includes a network 180, a control system 170, and a data store 160.

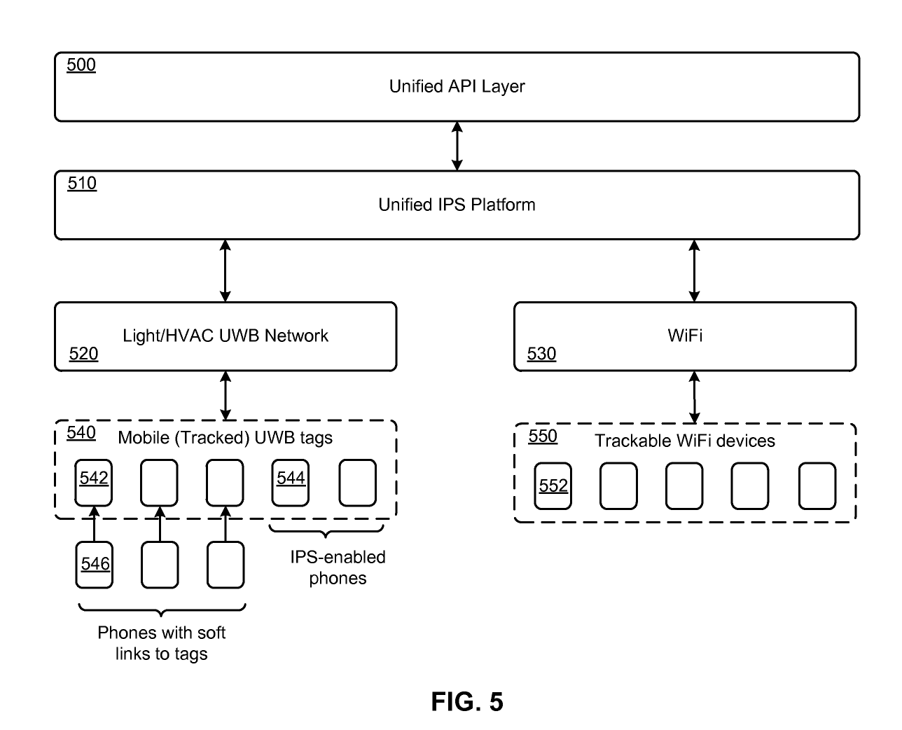

The network 180 can include any of a variety of data communication networks. For example, the network 180 may comprise a network implementing the IEEE 802.15.4 standard. The type of data communication network(s) utilized can depend on various factors, such as desired functionality of the BAS 110, cost considerations, network speed, and others. The network 180 can include one or more of a variety of architectures, including peer-to-peer, mesh, distributed, and/or centralized topologies. Furthermore, as discussed in more detail below in relation to FIG. 5, additional networks may be utilized, which can use different communication standards and/or technologies. To provide BAS functionality, network nodes such as data connection points or network components (not shown) can have sensors that collect and provide information regarding room temperature, local lighting intensity, humidity, movement, occupancy level, and the like. Moreover, some or all of the network nodes additionally can include controllers that enable the network nodes to change the temperature, lighting, humidity, etc., as desired. Thus, the BAS 110 can comprise a sensor network and/or distributed control system able to monitor and/or regulate various characteristics of a variety of locations in and/or nearby a building. The term “building,” as used herein is interpreted broadly and can refer to a wide variety of structures including, but not limited to home residences, office buildings, retail stores, manufacturing facilities, and the like, as well as surrounding areas. In some embodiments, elements described herein may be implemented in or associated with a structure, building, or portion thereof that is devoid of an enclosed space. For example, embodiments may be installed in an open-air stadium, a courtyard, or in a park, for example in combination with structures such as lights or light posts in the park. While the term “building” is used herein, the techniques disclosed can be applied to any structure. Further, while some embodiments may refer to a node, position, and/or location within a building, the techniques disclosed may be applied to other nodes, positions, and/or locations associated with a building. For example, a solar panel may be positioned on a roof of a building, or an asset may be located within a separate building (for example an annex, a storage shed, or another wing of a complex including a plurality of buildings).

Nodes within the network 180, as well as other components of the system 100, can be communicatively connected in any of a variety of ways. Such connections can include, but are not limited to optical, wired, wireless, satellite, and other communicative means. Moreover, the connections can employ any of a variety of common and/or proprietary protocols, switching, encryption, and/or other data communication techniques. Various combinations of such technologies may be utilized in a single network 180.

The BAS 110 also can include a control system 170. The control system 170 can comprise a computer, server, or other processing device configured to perform certain managerial functions for the BAS 110. Such managerial functions can include communicating with the network 180 to monitor and control lighting, air temperature, water temperature, alarms, security, etc., of all or any part of the building. The control system 170 can communicate with a data store 160, which can log sensor and/or control information, as well as preferences and other information that can impact the control of the BAS 110.

The control system 170 additionally may be communicatively connected with components outside the building and/or BAS 110. In the embodiment shown in FIG. 1, for example, the control system 170 is communicatively connected with a wide area network (WAN). The WAN 120 can be a network that covers a wide geographical region beyond the physical boundaries of the building or the network nodes of the BAS 110. The WAN 120 can include any of a variety of public and/or private networks, including the Internet. This connectivity can provide remote access to the control system 170, thereby enabling a user to remotely monitor and/or control the functionality of the BAS 110.

The BAS 110 can be enhanced with positioning technology by utilizing suitably functionalized fixed nodes 150, which can be communicatively linked to the BAS 110. In addition to serving the network communication and control functions of other nodes of the network 180, these fixed nodes 150 are capable of highly accurate ranging measurements. In one embodiment, for example, the fixed nodes include positioning functionality based on UWB wireless technology that can measure the distance between nodes with an accuracy to within one foot or better. In some embodiments, one or more of the fixed nodes 150 are integrated into an existing element of the BAS 110. For example, a fixed node may be integrated into a lighting element, a lighting control element, an appliance, a switch, or an outlet. In some embodiments, one or more of the fixed nodes 150 are implemented separately from existing elements of the BAS 110 and are configured for connection to or communication with the existing elements.

By including the fixed nodes 150 into the BAS 110, the backbone of a highly accurate indoor position location/tracking system can be established. Because the fixed nodes 150 (such as UWB-based nodes) can have a cost similar to low power radio nodes commonly utilized in BAS wireless networks, they may add little or virtually no cost to the overall system 100. Thus, the incorporation of fixed nodes 150 into the BAS 100 can result in a system 100 for tracking and locating assets or people within a building which has both high accuracy and low cost. Embodiments can include any number of fixed nodes 150 in the BAS 110. The resulting accuracy of the positioning information can increase with an increased number of fixed nodes 150. According to one embodiment, for example, a system for indoor positioning in smart buildings includes at least two fixed nodes 150. The fixed nodes 150, as well as other network nodes of the network 180 of the BAS 100, can be located at various points of a building, including (but not limited to) locations in the lighting system, installed appliances, electrical outlets, the HVAC system, and/or other parts of the building's physical plant. In embodiments where wireless ranging capability is integrated with elements such as lighting fixtures or HVAC devices, devices that are used during typical operation of the building and/or BAS may double as location or ranging devices, thereby providing a positioning function without adding additional devices, component costs, or installation costs to the system.

In addition to accurately determining their position with respect to the building, the fixed nodes 150 also can provide accurate location information of one or more mobile node(s) 130 in (or near) the building. The mobile node(s) 130 can be a portable or movable node, such as a UWB wireless device, which can be carried or otherwise moved in and/or around the building. In some embodiments, the mobile node(s) 130 can be attached to a semi-fixed apparatus, such as a table or light fixture, that is rarely moved. In other embodiments, the mobile node(s) 130 can be attached to an asset that can be tracked, such as a shopping cart, an item of merchandise, portable test or manufacturing equipment, or other movable device. The mobile node(s) 130 also can be integrated with and/or attached to an identification (ID) tag, badge, key fob, mobile phone, or other personal item that can be carried by a person, thereby permitting the system 100 to track the person's position in and/or around the building.

The mobile node(s) 130 can use minimal power and may therefore provide great versatility. For example, the mobile node(s) 130 can be battery powered and/or make use of energy harvesting techniques (e.g. electromagnetic induction). At some interval, or based on a triggering event such as detected motion or light, the mobile node(s) 130 can engage in ranging exchanges with the fixed nodes 150 of the BAS 110. This allows the BAS 110 to accurately determine the position of the mobile node(s) 130.

Any of a variety of suitable ranging techniques can be utilized, which may vary depending on the wireless technology utilized. For example, RSSI (received signal strength indicator) or time of flight (TOF) and/or round trip time (RTT) ranging operations enable a single pair of nodes to measure the distance between them. For example, a first fixed node can send a range request packet to a mobile node, where other fixed nodes detect the packet and note the time of arrival. The mobile node can then send a response, which is detected by the first fixed node and at least one other fixed nodes. The fixed nodes can then share measured time/distance information with each other, and calculate position data for the mobile node. Because fixed nodes may have a greater power budget than the mobile node (e.g., the mobile node is powered by a battery, and fixed nodes are connected to the building's power supply), the ranging operations can be adjusted so that fixed nodes are tasked with the more power-consuming operations than the mobile node (e.g., positioning calculations, transmission of data packets, etc.). This can also reduce or eliminate certain components of a mobile node (e.g., microprocessor, ROM/flash memory, RAM, etc.). It can be noted that, although the embodiment of FIG. 1 indicates determining the location of a mobile node 130 using fixed nodes 150, any combination of fixed, semi-fixed, and/or mobile nodes can be used to determine the location of any other type of node (e.g., fixed, semi-fixed, and/or mobile).

In some embodiments, the signals used for wireless ranging may be similar to signals used to communicate in the BAS. For example, the BAS may communicate according to an IEEE 802.15.4 standard, and the wireless ranging signals may be implemented according to the same IEEE 802.15.4 standard. In some embodiments, the operation of typical wireless devices in a BAS may be modified to allow these devices to send or receive wireless ranging signals. In some embodiments, the signals used to communicate control information or data in the BAS differ from the signals used for wireless ranging.

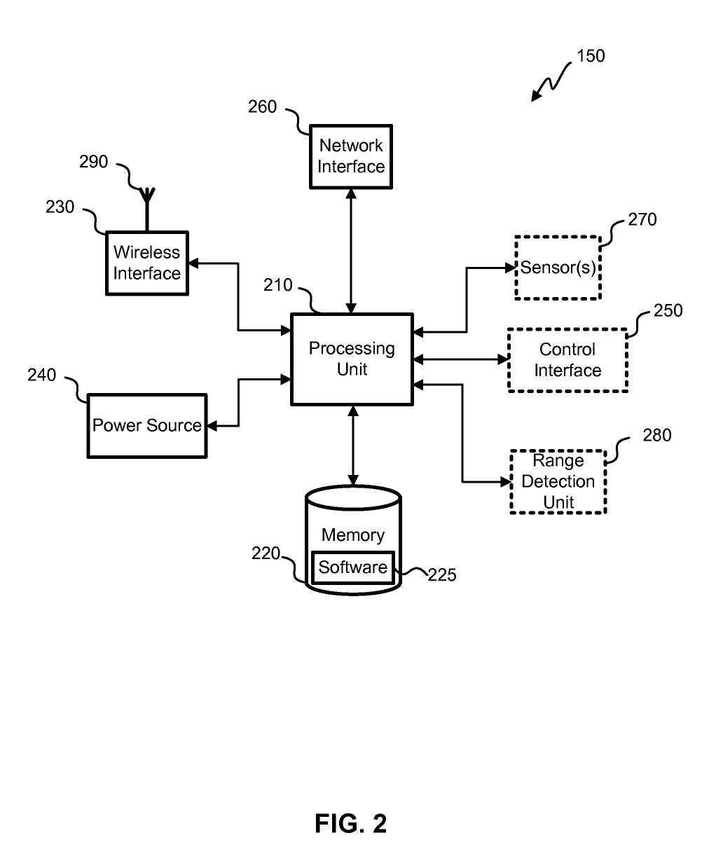

FIG. 2 is a simplified block diagram of an embodiment of a fixed node 150. As with other figures shown herein, this block diagram is provided as an example only, and is not limiting. The fixed node 150 can be configured in any of a variety of ways. Moreover, components may be combined, separated, omitted, or substituted, without departing from the spirit of this disclosure.

The fixed node can include a processing unit 210 comprised of one or more processors, microprocessors, application specific integrated circuits (ASICs), digital signal processors (DSPs), specialized circuits, and/or other logical circuits. Among other things, the processing unit 210 can process the information in accordance with software 225 disposed in memory 220 and communicate with the other components of the fixed node 150. Depending on desired functionality of the fixed node 150 and the capabilities of the processing unit 210, the software 225 can include firmware, software, and/or microcode for the processing unit 210 to execute.

A power source 240 is provided to supply power to the components of the fixed node 150. Additionally, the power source 240 may provide information (e.g., battery charge status, voltage levels, etc.) to the processing unit 210. The nature of the power source 240 can vary, depending on application. For example, the power source 240 can provide power through wired, wireless, and/or stored means. Such embodiments can include one or more batteries, inductive couplers, power converters, transformers, solar cells, voltage regulators, and the like. Additionally or alternatively, components of the fixed node 150 can receive power through a communication interface, such as the network interface 260 and/or a wireless interface 230.

The wireless interface 230 utilizes an antenna 290 to allow the fixed node 150 to engage in ranging exchanges with other wireless nodes. This communication can be effectuated using any of a variety of radio frequency (RF) technologies. In addition (or as an alternative) to UWB technology discussed previously, such RF technologies can include, for example, IEEE 802.15.4, IEEE 802.11, Bluetooth®, IEEE 802.16, 433 MHz Industrial Scientific and Medical (ISM) Band, cellular, RF identification (RFID), and more.

The fixed node 150 also can also include a network interface 260, which can allow the fixed node 150 to communicate with the network 180 of the BAS 110. Depending on the functionality of the fixed node 150, such communication can include information regarding sensor information from the fixed node 150 to the network 180 as well as control information from the network 180 to the fixed node 150. According to some embodiments, raw position data may be relayed from the fixed node through the network interface 260, allowing other devices of the BAS 110, such as the control system 170, to determine the corresponding position of a node (e.g., the fixed node 150 or a mobile node 130 with which the fixed node 150 exchanged ranging information). In other embodiments, the determination of the node position may be carried out by the processing unit 210 of the fixed node 150 and/or relayed from the mobile node 130 to the BAS 110 via the fixed node 150. The network interface 260 can employ any of a variety of communication technologies (e.g., optical, wireless, or wired) to communicate with the network 180 of the BAS 110. In embodiments where wireless technology is utilized, the network interface 260 may be integrated with the wireless interface 230. In some embodiments, a dedicated range detection unit 280 may be used to take range measurements. In some embodiments, the range detection unit 280 may additionally determine range, position, and/or location.

Depending on desired functionality, the fixed node 150 further can include sensor(s) 270, enabling the fixed node 150 to collect sensor information similar to other nodes in the network 180 of the BAS 110. This sensor information can include information relating to temperature, humidity, movement, room occupancy, light, shock, and others. Depending on desired functionality, the processing unit 210 may collect, process, and/or record the sensor information, or the processing unit 210 simply may send unprocessed sensor information to the BAS 110 using the network interface 260.

Also, depending on desired functionality, the fixed node 150 further can include a control interface 250, enabling the fixed node 150 to control one or more systems of the BAS 110. The control interface 250, which can be employed on other network nodes in the network 180 of the BAS 110, can enable the fixed node to control, for example, the heating and/or lighting for a particular room or area in or near the building. The control interface 250 may include, for example, a switch, a dial, a keyboard, or a touch screen that allows a user to input or receive control information.

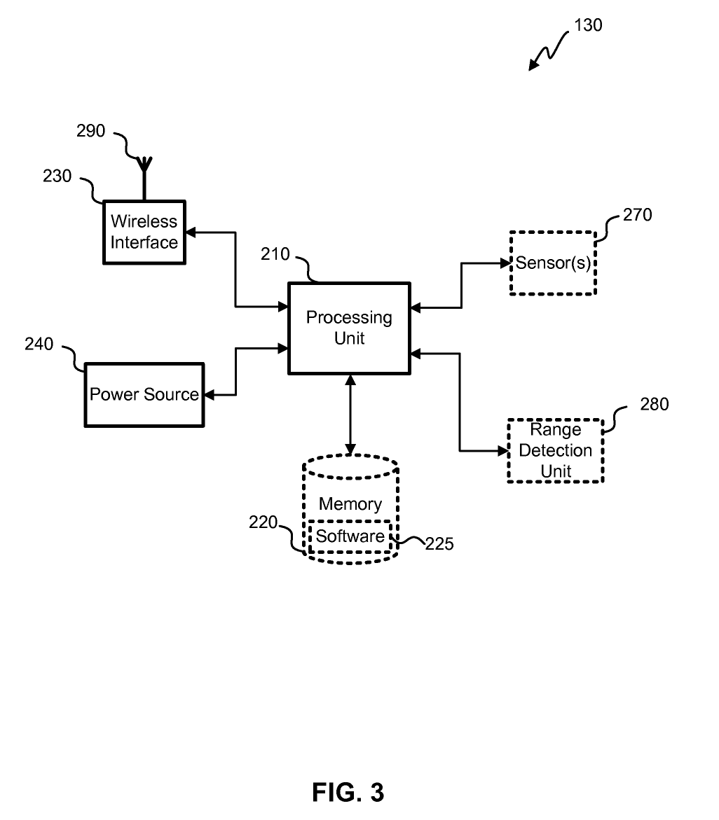

FIG. 3 is a simplified block diagram of a mobile node 130, according to one embodiment. Similar to the fixed nodes 150, the mobile node 130 can include a wireless interface 230, a power source 240, a processing unit 210, memory 220, one or more sensor(s) 270, and a range detection unit 280. Moreover, such components can have functionality similar to the corresponding components of the fixed nodes 150 described above. Because mobile node 130 may have limited power in comparison to the fixed nodes 150, the functionality of the components can be adjusted to utilize less power. In some particularly low-power embodiments such as badges or equipment identification tags, mobile node 130 may include dedicated circuitry in processing unit 210, a wireless interface 230 with an antenna 290, and a power source 240.

The integration of an accurate position measurement system into a BAS, as provided herein and utilizing the system and components shown in FIGS. 1-3, can yield enhanced functionality and benefits across a variety of areas including: (1) automation of the system installation and/or installation of components thereof, (2) automation of building operations, and/or (3) tracking of people and assets within the building.

With regard to automation of the system installation, one significant expense associated with installation of a wireless control system can be the “commissioning” process. This includes making an account of the physical location of each element of the system and associating those locations with elements of the physical plant, such as a lighting fixture or a ventilation controller. The ranging capability of the present invention, however, can provide for the automation of the system installation and/or nodes therein, thereby helping to lower the cost of installation of the BAS 110.

Such automation of the system installation (i.e., automatic commissioning) can be accomplished a variety of ways. This can include automatic mapping of radio nodes onto a map of the building or automatic linking of sensors to controllers. For example, overhead lights may be automatically linked to nearby switches, occupancy sensors, or light-level sensors, or thermostats may be linked to adjacent HVAC controllers. The automation of the system installation further can include automatic grouping of network nodes based on knowledge of their locations within a building. In some implementations, all nodes in a room or on a single floor, nodes in a particular type of space such as hallways, open office areas, private offices, labs, retail spaces, or storage spaces, or nodes that are physically close to a central gateway, router, server or backhaul node may be automatically associated into a group. For example, the incremental installation of an appliance such as a cooler or a wall-mounted sconce can include automatic device detection and position determination within the building, followed by automatic grouping with other devices in a particular room or type of space. The automation of the system installation further can include discovery and optimization of mesh network routing based on knowledge of the physical layout of the nodes, and/or automatic reorganization and or remapping of network nodes based on the discovery that a previously fixed node has been physically relocated. In contrast to only integrating a node into a mesh network, for example, the physical location of the node or position of the node with respect to a map or structure, such as an infrastructure element, may be utilized during the commissioning and/or operation of the BAS. For example, the replacement of an overhead light or the movement of an equipment bench into another room can be discovered and remapped by a BAS having functionalized indoor position determination capability. In another example, the routing of packets in a meshed network can be simplified or optimized by minimizing the number of hops between various nodes in the network based on the ascertained physical locations of the nodes.

During the automatic commissioning of wireless components of a BAS, it may be beneficial to know something about the attributes or properties of various nodes within the system. As discussed herein, nodes may have different attributes or properties that, when deployed within a system allow the system to perform a broad range of functions. Moreover, some or all of the attributes or properties that are used to enable an automated commissioning may be the same attributes or properties used later during operation of the building. Such attributes or properties can take several different forms.

One type of attribute might consist of an inherent attribute of the node, which is fixed at the time of manufacture. For instance a lighting controller has the inherent property that it is capable of controlling lights.

Table 1 includes a list of some examples of inherent attributes of a wireless fixed, semi-fixed or mobile node that might be useful during automatic commissioning of that node. The list of Table 1 is provided as a non-limiting example. Nodes may have greater or fewer inherent attributes, and/or may have inherent attributes that are not listed.

TABLE 1
Example Inherent Attributes of a Node

Power Supply (grid, battery, etc.)
Mobility (fixed, mobile, etc.)
Communication Type (unidirectional, bidirectional, etc.)
Controllable Parameters
Sensing Capabilities
Supported Protocols For Communication (Legacy And Otherwise)
Supported Frequency Bands
Equipment Identification Number (EIN)
Ranging Capabilities
Support of Asymmetric Ranging Operations
Product Information (e.g., Manufacturer, Model Number,
Specifications, Capabilities, etc.)
Supported Configurable Parameters

Another type of attribute or property might consist of a configurable attribute, which can be set during installation as part of commissioning or prior to commissioning. The configurable attribute may remain set in this configuration for a substantial duration, during which time the configuration is considered as a fixed property of that node. For instance a given light controller might be configured as a hallway lighting controller or a conference room lighting controller. At some later time the configuration might be changed to reflect a new circumstance, such as a reconfiguration of the space within a building.

Table 2 includes a list of some examples of configurable attributes of a wireless node that might be useful during automatic commissioning of that node. In some instances these configurable properties could override inherent properties. Again, the list of Table 2 is provided as a non-limiting, non-exhaustive example.

TABLE 2
Example Configurable Attributes of a Node

Power Supply (grid, battery, etc.)
Mobility (fixed, mobile, etc.)
Communication Type (unidirectional, bidirectional, etc.)
Ranging Capabilities
Support of Asymmetric Ranging Operations
Level of Activity (e.g., duty cycle, or whether the node is normally in a
dormant state and the periodicity by which it wakes up to communicate
with the BAS)
Priority Level (e.g. whether the node is a reference node for geophysical
location determination)

A third type of attribute or property might consist of a status attribute, which can change according to a current state of the node. A status attribute may be updated automatically in near-real time to reflect current information, such as the light output state of a lighting controller, the current On/Off state of a light switch, and so forth.

Table 3 includes a list of some examples of status attributes of a wireless node that might be useful during automatic commissioning of that node. In some instances these status attributes could override inherent properties or configurable properties. Again, the list of Table 3 is non-limiting.

TABLE 3
Example Status Attributes of a Node

Power Supply (grid, battery, etc.)
State of Use (i.e., in use or not)
State of Control(s)
State of Interface(s)
Sensor Reading(s) from Node Sensor(s)

Inherent, configurable, and/or status attributes, as described above, can be used during the automatic commissioning of wireless components of a BAS in order to facilitate that process. Furthermore these attributes can be used during the operation of the building in order to provide energy savings, improved comfort for the occupants, improved productivity within the building, or to achieve other goals according to the needs of the building occupants.

One scenario wherein the automatic commissioning of wireless components of a BAS might be used would be for control of the lighting within the building. Based on measured distances between various nodes in the building and knowledge of the inherent, configurable, and/or status attributes of those nodes, an automatic mapping of lighting fixtures, switches, daylight sensors, and occupancy sensors onto a map of the building may be accomplished. Certain devices may associate themselves with each other according to their measured distances, and taking into account the attributes of each device.

For example, a lighting unit could associate itself automatically with a nearby light switch. Attributes of nodes associated with a particular lighting unit may include: whether the light has access to battery backup or emergency power; whether the lighting unit may be mildly mobile such as a desk lamp; the extent to which a light is dimmable; whether the light has a built-in light output detector or a motion detector; the power rating of the light; and the type of light that is delivered such as spot, flood, hallway, color temperature or current wattage. In some embodiments, if a new light switch is added, or an existing light switch is replaced, the switch will automatically be commissioned to control lights within a certain area, for example based on the location of the switch and the locations of surrounding lights and information indicating that the switch is configured to control up to a certain number of lights. Thus, even if the lights are not physically coupled to the switch, the switch may be able to control the lights. Further, the added switch may introduce additional capabilities in some embodiments.

Another scenario wherein the automatic commissioning of a wireless BAS might be used would be for control of the HVAC within the building. Based on measured distances between various nodes in the building, and knowledge of the inherent, configurable, and/or status attributes of those nodes, an automatic mapping of heaters, chillers, variable air valves, thermostats, CO₂ sensors, and humidity sensors onto a map of the building could be accomplished. A building map may also contain information about physical connections between HVAC elements. Certain devices may associate themselves with each other according to their measured distances, and take into account the attributes of each device. For example, a variable air valve may associate itself automatically with a nearby thermostat. Information about physical connections may further inform the automatic commissioning, such as a chiller that automatically associates itself with a set of variable air valves based on both measured location and information from a building map about physical connections. In some embodiments, an alert may be generated in the BAS and/or at one or more nodes in the BAS when additional control would be beneficial. For example, when a light switch is removed, there may be an alert that sufficient control is unavailable from other nearby light switches or that an additional switch is required to control a certain area with a desired functionality. Another example may include detecting when an air conditioning or heating level in adjacent areas is constantly and/or oppositely adjusted. This may indicate that additional HVAC controllers would be beneficial such that smaller areas may be controlled by each controller.

Yet another scenario for automatic commissioning may be used for an asset tracking system, consisting of a set of fixed wireless nodes installed on a semi-permanent basis within the building, and a set of mobile (e.g., portable) wireless nodes. The fixed nodes, which may also be elements of a lighting or HVAC control system, can be used to determine range to the mobile nodes, which may be employee badges and/or asset tags attached to equipment, in order to locate those mobile nodes within the building. During the automatic commissioning process the nodes having the “fixed” attribute or configuration can perform ranging to other such nodes (fixed or mobile), in order to learn their positions within the building. During this process, nodes without the “fixed” attribute or configuration (i.e. the mobile nodes) may be ignored in some embodiments. In other embodiments, mobile nodes may be considered if their location is known. For example, a confidence of the known location may be used to determine the position of the node having an unknown position, or the known location may be used when it is associated with a confidence over a certain threshold. Other attributes associated with a mobile node such as an employee badge or equipment tag may include: whether the node can operate in a beacon mode, a bi-directional ranging mode, or an asymmetric ranging mode; the remaining life of an internal battery; a time window for waking up and reporting a current position; and information about the equipment, asset, or employee.

Other scenarios for an automatically commissioned BAS can include scenarios in which various wireless elements are used for sensing and/or control of some nature. In such configurations, the BAS may be able to automate the process of commissioning these elements to a greater or lesser extent, and operate and control the buildings physical systems by making use of these wireless elements.

Higher levels of sophistication in the automation and control of the building can be achieved, based on having the combination of control and/or sensing of the BAS coupled with the ability of the BAS to measure and/or locate the positions of people and/or assets within the building. For example the set point for the temperature of a given room could be altered based on knowing the number and preferences of the occupants of that room at any given time, or to give priority to the preferences of a high-level executive in the room. In another example the lighting in a shared office might be adjusted to more closely align to the preferences of one remaining occupant when other occupants leave the office. Additional examples are provided below.

The attributes of a particular node used in conjunction with a building automation system can vary widely, as indicated in the various scenarios and examples herein. The attributes may be stored in a memory associated with the node. Attributes that are an inherent property such as manufacturer, electronic identification number, and product information may be stored permanently in memory (e.g., in a read-only portion of memory), with fields of 1 bit to 64 k bits and larger dedicated to these attributes. Attributes that are configurable such as wireless protocol or reporting schedule may have an initial default value set by the manufacturer that is upgradeable by the BAS during commissioning and/or dynamically during operation. Thus, the commissioning may comprise adjusting a setting or attribute of a node. These attributes may be stored in fields that are alterable by the BAS. Status attributes such as whether a device (e.g. desk lamp) is in use, the light level or temperature in a room, or room occupancy, can also be stored in fields that are regularly updated and accessible to the BAS for dynamic building sensing and control. A person having ordinary skill in the art will recognize many modifications, alterations, and substitutions.

With regard to automation of building operations, by making use of information about the occupants of a building, techniques provided herein can enable the building systems to be operated more efficiently, and/or operate to anticipate needs rather than simply reacting to changing sensor readings. For example, automation of building operations can include automatically adjusting HVAC in areas where a large number of building occupants congregate, adjusting lighting within a room based on locations of occupants within the room, automatically providing lighting for janitorial staff, emergency personnel, maintenance workers, security personnel, etc., and/or automatically controlling physical access of occupants to certain parts of a facility based on their identity (e.g., unlock certain doors for a certain class of visitors or users, etc.). In some embodiments, a position of an individual or device may be used to affect operation of an element of the BAS, and/or an identity of the individual or device may be used to affect operation of an element of the BAS. In some embodiments, the building state may be changed based on the position of one or more mobile nodes in or near the building. For example, the building HVAC may be adjusted to maintain room temperature in a particular room based on the detection of multiple people in the room.

Such automation can be utilized in a variety of scenarios. In an office environment, for example, such automation can be used to quickly locate coworkers for impromptu meetings and/or locate portable equipment. In a retail environment, such automation can be used to connect advertisers with consumers who are standing next to particular merchandise, help understand how customers move through the space, and facilitate navigation (e.g. answer the question “Which way to the shoe department?”). In a health care facility, the ability to track and locate people and assets can help answer the following example questions: Where is Doctor Jones? Where is the portable EKG machine? Why is patient Smith wandering around in the stairwell again? It can also help provide for contactless (sanitary) access control, fine grained control over visitor access to internal parts of the facility, and automatic notification if an asset/occupant enters or leaves a controlled area. In a warehouse or factory, such automation can help track and optimize material movements and/or enable precise indoor robotic navigation. In a museum, such automation can help answer the questions: Where is the “Mona Lisa”? Where is the café? In a hotel, such automation can help answer the following questions: Where is my room? Where is the meeting room? Where is the workout room? In recreational contexts, such automation can help answer the following questions: Where are my laser tag teammates? How far did I swim? Other miscellaneous uses can include: finding a colleague for an urgent face-to-face chat, receiving automatic notifications when someone arrives in his/her office or when several colleagues are all present nearby for a face-to-face chat, locating an empty conference room, finding out where colleagues are conducting an impromptu meeting, finding a piece of “loaner” or “floating” equipment without interrupting colleagues to track it down (an enterprise might buy fewer such assets if they were more easily located and shared, which also saves money), checking on wait times for a shared resource such as a company cafeteria, and automatically turning lights on and off for a janitor to prevent the usual case where a large area is illuminated during cleaning. Numerous other use cases are contemplated.

With regard to tracking of people and assets within the building, the ability to track the movements of building occupants or assets very accurately opens up a number of interesting and useful possibilities. Such possibilities can include discovering the routes/spaces commonly used by occupants of the building, discovering routes or areas that are under under-utilized, discovering patterns of association of building occupants in order to optimize their organization and/or locations, and optimizing the number and location of assets within a space based on occupant usage patterns. Such information can be particularly useful in retail and/or commercial environments. Tracking people and assets within the building further can provide information to first responders regarding the last known positions of building occupants in the event of an emergency, facilitate the determination that a building has been evacuated in an emergency, and guide emergency responders to a particular location in a building (e.g., by flickering lights along a hallway or in a particular room). The positioning system can be used to generate one or more messages based on the determined position of one or more mobile nodes in or near a building. In some embodiments, a message can be generated by the indoor positioning system to alert a recipient when a predetermined configuration of mobile nodes is satisfied. For example, a message can be sent to a meeting organizer alerting him or her that all meeting participants are present in a particular meeting room.

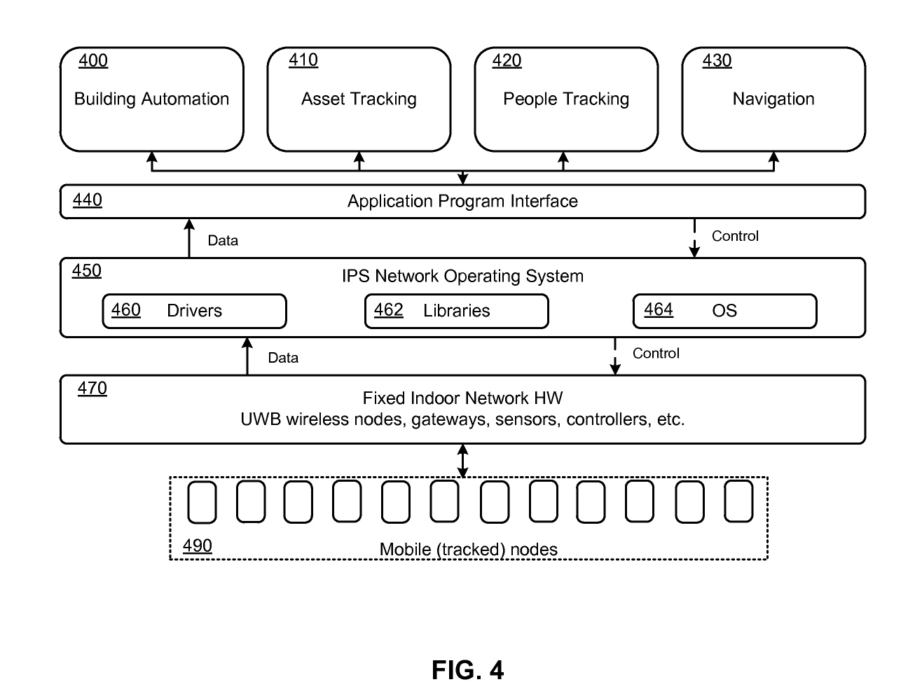

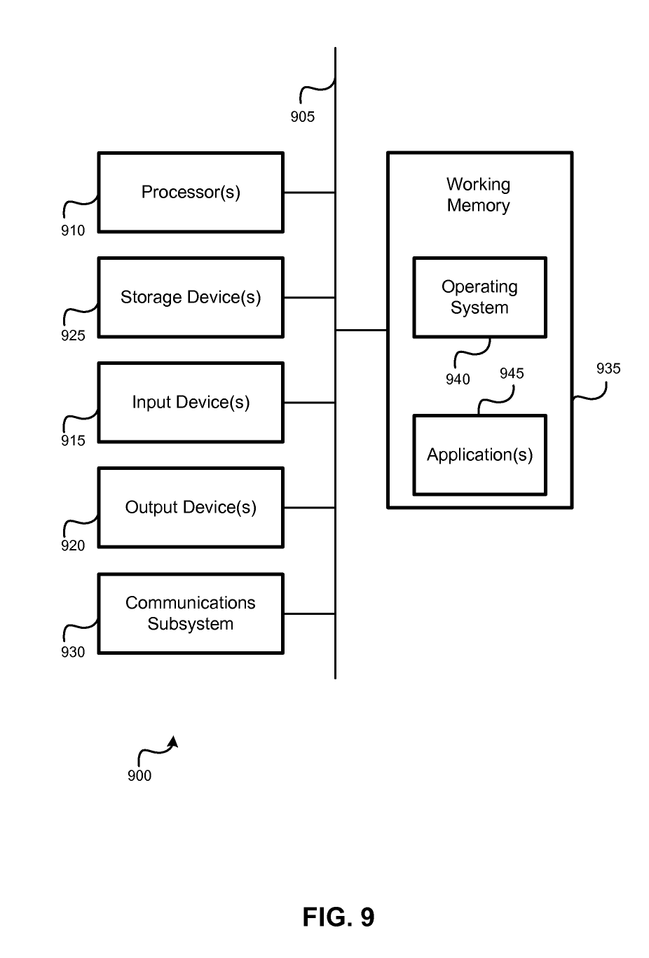

FIG. 4 is a simplified block diagram of a system level view of various components of an indoor positioning system platform, showing hardware, software, and other functional components that can be integrated to provide the functionality described herein. Fixed nodes are included with the infrastructure of the building physical plant, shown as fixed indoor network hardware 470. These fixed nodes can include the fixed nodes 150 described in FIGS. 1 and 2, which can implement one or more of the features of the computer system described in more detail below in relation to FIG. 9. Fixed nodes and/or other fixed indoor network hardware 470 can communicate with one or more mobile nodes 490. The mobile nodes 490 can include the mobile nodes 130 described in FIGS. 1 and 3, which can also implement one or more of the features of the computer system described in more detail below in relation to FIG. 9. The fixed nodes can communicate with an indoor position system network operating system 450, which can consist of one or more drivers 460, one or more libraries 462, and an operating system (OS) 464. IPS network operating system 450 can coordinate, control, and aggregate data from one or more fixed or mobile nodes in order to determine the position of and track the fixed and/or mobile nodes and to control the physical plant of the building. Various services can make use of the position data of the fixed and mobile nodes by way of an application program interface (API) 440. In one embodiment these services can include building automation 400, asset tracking 410, people tracking 420, and/or indoor navigation services 430, among other services.

One or more of the components of the indoor positioning system platform can be managed and/or executed by a control system, such as the control system 170 of the BAS 110 shown in FIG. 1. The control system can include one or more computer systems, such as the computer system described in more detail below in relation to FIG. 9. The component(s) managed and/or executed by a control system can include the IPS network operating system 450, drivers 460, libraries 462, OS 464, API 440, building automation 400, asset tracking 410, people tracking 420, and/or navigation 430, depending on desired functionality.

FIG. 5 is a simplified block diagram of a system having multiple wireless networks integrated into an indoor positioning system (IPS) platform with a unified application programming interface (API) layer, such as the API 440 of FIG. 4. The block diagram shows one embodiment of how several different location tracking systems can be combined. In this example, one location tracking system is embedded into the BAS while another system uses a WiFi network. A unified API layer 500, which can be executed by a control system, such as the control system 170 of FIG. 1, aggregates and presents position data from the unified indoor positioning system 510, which also can be executed by a control system. IPS 510 can communicate with one or more position tracking subsystems such as a trackable WiFi network 530. WiFi network 530 can communicate with one or more trackable WiFi devices 550, such as trackable WiFi device 552, to provide position tracking capability. A second position tracking subsystem such as a trackable UWB network 520 can also be interconnected with the BAS. UWB network 520 can communicate with one or more mobile nodes 540 such as mobile node 542 and mobile node 544. Mobile nodes 540 can correlate to mobile node(s) 130 as shown in FIG. 1, which may comprise different components, including some or all of the components shown in FIG. 3. In some embodiments, WiFi devices 550 may also correlate to the mobile node(s) 130 as shown in FIG. 1.

Various types of trackable devices are shown in FIG. 5. Mobile node 542 can be a tag which has been associated with a mobile phone 546, such that navigation data or other position-dependent data might be directed to the phone. The association between 542 and 546 may be temporary. For example, mobile node 542 can be built into a shopping cart, so that relevant, position-dependent information about a store might be provided to mobile phone 546 while the owner of the phone is using the cart. The association between 542 and 546 might be established using NFC, Bluetooth, a QR code, or other mechanism that enables such a temporary association to be established. The association between mobile node 542 and phone 546 might also be longer-lived, such as an association between an employee badge and that employee's mobile phone. Mobile node 544 might be a mobile phone with built-in tracking capability, which can be directly tracked by the fixed UWB network 520.

For both FIGS. 4 and 5, the platform can provide an API layer for use by service providers targeting the various control, sensing, location and service applications types within a building. The building automation functions can be wrapped into existing protocols such as BACnet, so that it will interface easily to the many existing solutions in that space. For an office environment, a plug-in for Microsoft® Outlook enables integration of people-finding capabilities. Other custom applications can be developed for web-based services accessible through mobile phones, such as finding colleagues or specific equipment.

The IPS systems of FIGS. 4 and 5 can complement and leverage positioning technologies suited to handset-based navigation services that may also utilize WiFi for low-accuracy tracking and navigation. As indicated in FIG. 4, a common application platform could support a full range of devices and services. IPS systems can include WiFi as part of the network structure for backhaul to the server, so the increased accuracy of systems discussed herein can complement the tracking of existing WiFi-enabled devices.

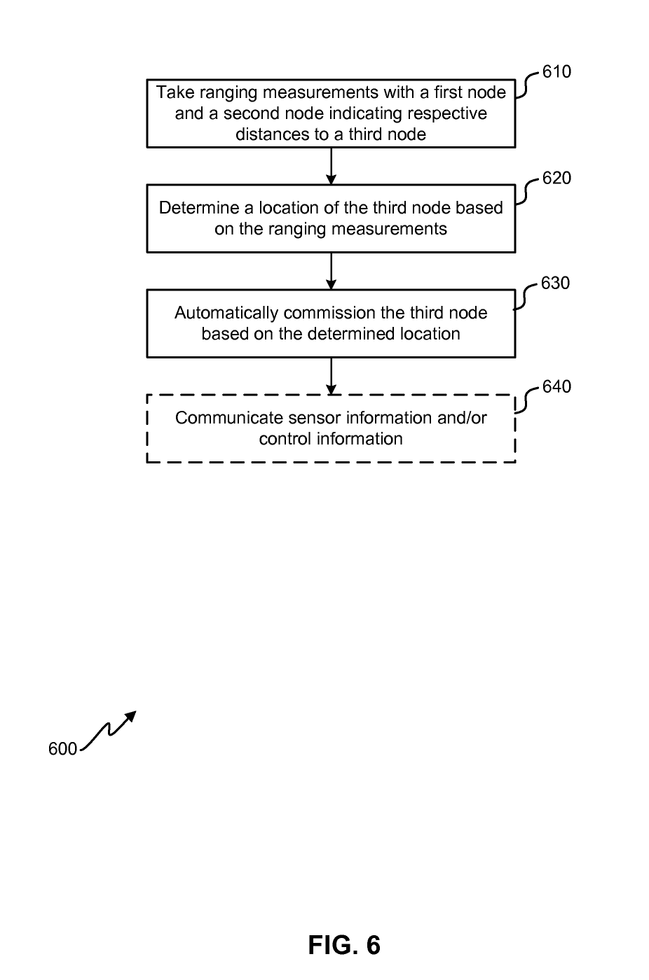

FIG. 6 is a simplified flow diagram of a method 600 for commissioning a node using a network of communicatively-connected components, according to one embodiment. Means for performing each step of method 600 can include hardware and/or software components, such as detailed herein above with regard to FIGS. 2-5, and/or those detailed below in regard to FIG. 9. For example, the method 600 may be performed using one or more components of a BAS, such as the mobile node(s) 130, fixed node(s) 150, network 180, control system 170, and/or data store 160 of the system 100 for indoor positioning of FIG. 1.

At block 610, ranging measurements can be taken with a first node and a second node indicating respective distances to a third node. In addition or as an alternative to the means discussed above, means for performing this function can include a wireless interface 230, processing unit 210, software 225, and/or additional components shown in FIGS. 2 and 3. The nodes can utilize wireless interfaces to take the ranging measurements using, for example, RTT, TOF, and/or RSSI. As detailed above, any of the first, second, or third nodes can be fixed, semi-fixed, or mobile. Moreover, the nodes can be configured such that more power is used by the fixed nodes (i.e., nodes that are likely to have a plugged-in power supply) during ranging processes than by mobile nodes (i.e., nodes that are likely to have a battery or other low-power power supply).

The location of the first node and the second node can be known, thereby enabling for triangulation or trilateration of the third node and determination of the location of the third node based on the ranging measurements, at block 620. In addition or as an alternative to the means discussed above, means for performing this function may include a processing unit 210, software 225, and/or additional components shown in FIGS. 2 and 3. Depending on the desired functionality, configuration, and/or other factors, ranging information from additional nodes besides the first and second nodes can be used to make the determination of the third node's location. The use of additional nodes can increase the accuracy and/or precision of the determined location. Furthermore, as indicated above, if the third node is a semi-fixed or mobile node, it may be tracked throughout a building or other structure, and messages can be generated and sent based on the location of the node. In some embodiments, one or more sensors at the third node may be used to disambiguate between several potential locations. For example, when the third node is determined to be located in one of two positions, or on either side of a particular wall in a building, a camera at the third node may capture an image or a thermometer or other sensor may be used to distinguish between the positions.

At block 630, the third node is automatically commissioned, based on the determined location. In addition or as an alternative to the means discussed above, means for performing this function can include a wireless interface 230, processing unit 210, software 225, and/or additional components shown in FIGS. 2 and 3. Commissioning the third node can include associating the third node with one or more components of the network, such as sensor(s), control(s), actuator(s), and/or other node(s). This association not only can be location based, but can also be based on any of a variety of attributes, such as the inherent, configurable, and/or status attributes previously described. For example, a certain node may have an inherent attribute for sensing light. This attribute, together with location and/or other attributes, can be received from the node being commissioned and/or used in commissioning the node such that the node being commissioned is associated with one or more nearby lights and/or light switches to help determine the operability of the nearby light(s) and/or light switch(es). Additionally or alternatively, if the certain node has an actuator and/or control, it may be commissioned to control the nearby light(s). Of course, nodes may have any of a variety of attributes and other features, so commissioning can vary from node to node. In this way, any of a variety of types of nodes may be automatically commissioned for use within the BAS.

Optionally, at block 640, these node(s) and/or other component(s) can communicate sensor information and/or control information, enabling smart building functionality. In addition or as an alternative to the means discussed above, means for performing this function can include a wireless interface 230, processing unit 210, software 225, and/or additional components shown in FIGS. 2 and 3. Such sensor and/or control information can cause the status of at least a portion of a structure to be altered, based on the determined location of the third node. For example, the status of a light control in a room may change from off to on if the third node coupled with an employee badge is determined to have entered the room.

Some nodes may be commissioned to take a more passive role, and may not communicate sensor information and/or control information. For example, some nodes with unidirectional communication attributes or in which sensors are omitted may be configured to perform functionality based on the received control information, but may not communicate sensor information and/or control information. In such instances, the functionality described in block 640 may not be performed.

It should be appreciated that the specific steps illustrated in FIG. 6 provide an example method for providing indoor positioning using a network of communicatively-connected components. Alternative embodiments may include alterations to the embodiments shown. Furthermore, additional features may be added or removed depending on the particular applications. For example, specific ranging techniques may be utilized, specific sensor and/or control information may be communicated, attribute information may be communicated and/or altered, etc. One of ordinary skill in the art would recognize many variations, modifications, and alternatives.

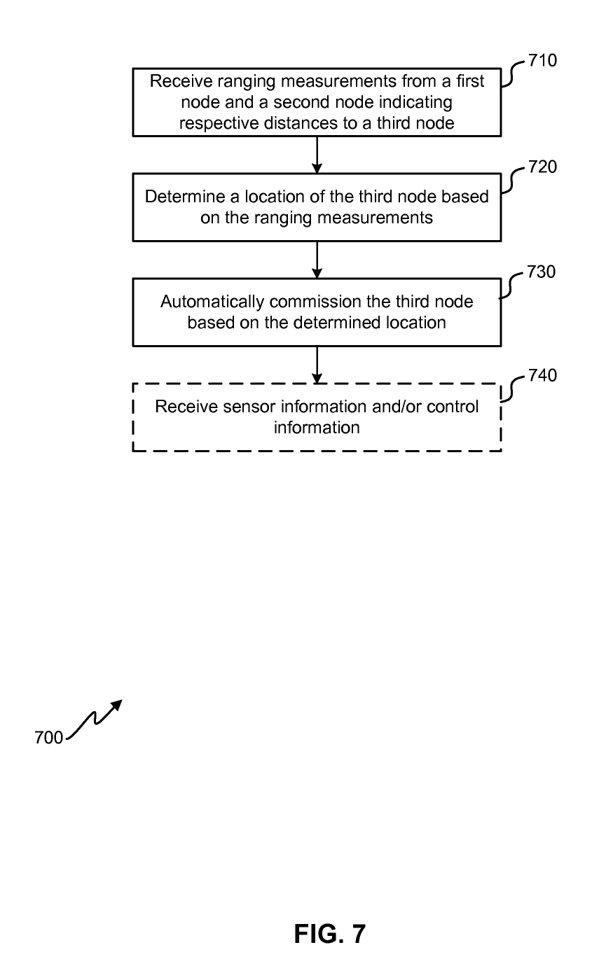

FIG. 7 illustrates an embodiment of a method 700 for commissioning a node similar to the method 600, illustrating how certain steps may be performed by a centralized system. Means for performing each step of method 700 can include hardware and/or software components, such as the computer system described in regards to FIG. 9. In particular, the processor(s) 910, communications subsystem 930, and/or application(s) 945, and/or other components of the computer system described in regards to FIG. 9 can be used to perform one or more steps of method 700. The control system 170 of the system 100 for indoor positioning of FIG. 1, or some other computer system, can comprise a computer system shown in FIG. 9 and may therefore be configured to perform one or more of the steps of the method 700. That said, embodiments may allow for multiple systems (e.g., cloud-connected servers) to perform some or all of the functions described in regard to FIG. 7. In some embodiments, one or more of the steps of method 700 may be performed by the first or second node recited with respect to block 710 below.

At block 710, ranging measurements from a first node and a second node are received, indicating respective distances to a third node. The system receiving this information can then, at block 720, determine the location of the third node based on the ranging measurements. This determining can be done if the location of the first and second node is known. The location of these nodes can be stored in a memory (e.g., the data store 160 of FIG. 1) and/or communicated to the system by the nodes themselves and/or other components of the indoor positioning network. The location information for nodes can vary in type and format, depending on desired functionality. It can, for example, indicate a location relative to a certain point within the building (or relative to any point, for that matter) by using latitude, longitude, altitude, Cartesian coordinates, and/or other location information.

At block 730, the third node is automatically commissioned, based on the determined location and/or one or more attributes of the third node. As discussed previously, commissioning the third node can include associating the third node with one or more components of the network, and may be executed and/or initiated by a central system overseeing at least part of the commissioning process. Optionally, at block 740, sensor information and/or control information regarding at least a portion of a structure (e.g., a room in which one or more of the nodes is located) is received from any of the first, second, and/or third nodes. As indicated previously, certain nodes may simply receive information from the network or omit sensors rather than communicate sensor information and/or control information. In such instances, the functionality described in block 740 may not be performed.

As with FIG. 6, it should be appreciated that the specific steps illustrated in FIG. 7 illustrate an example method for providing indoor positioning using a network of communicatively-connected components. Alternative embodiments may include alterations to the embodiments shown. Furthermore, additional features may be added or removed depending on the particular applications. One of ordinary skill in the art would recognize many variations, modifications, and alternatives.

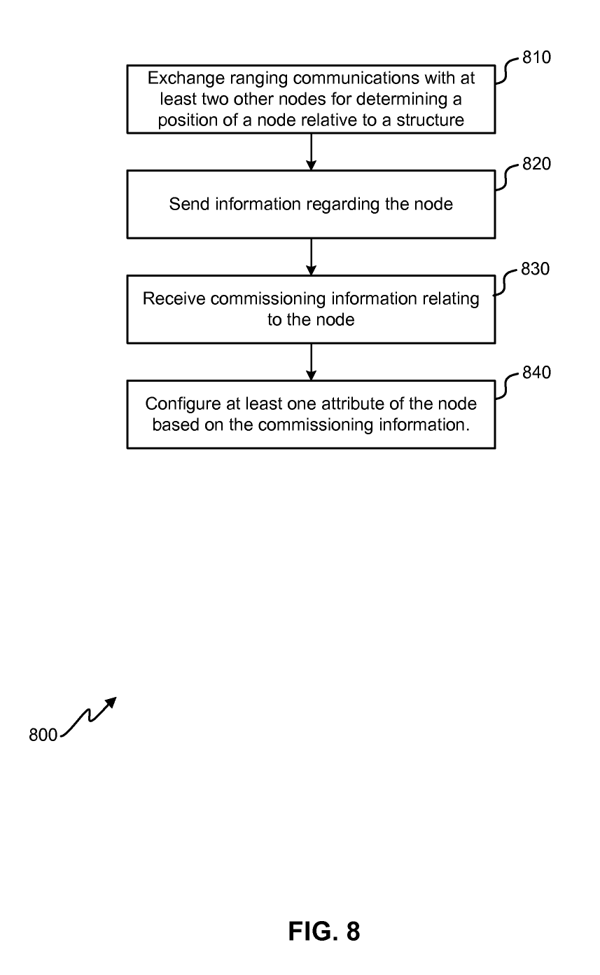

FIG. 8 illustrates an embodiment of a method 800 for commissioning a node in a positioning network. The method can be performed by, for example, a mobile node, such as the mobile node 130 of FIG. 1. Accordingly, means for performing each step of method 800 can include hardware and/or software components, such as those shown in FIG. 3. In particular, the processing unit 210, wireless interface 230, software 225, range detection unit 280, and/or other components of the mobile node 130 described in regards to FIG. 3 can be used to perform one or more steps of method 800. Additionally or alternatively, the method may be performed by one or more components of a computer system, such as the computer system described below in regards to FIG. 9.

At block 810, ranging communications can be exchanged with at least two other nodes to determine a position of the node relative to a structure (e.g., a building) or a map. As discussed above, where the position of the at least two other nodes is known, a position of the node can be determined Exchanging ranging communications can include, for example, exchanging information relating to RSSI, TOF, and/or RTT, e.g., using UWB communications.

At block 820, information regarding the node is sent. For example, the node can send information to one or more of the other nodes with which the node exchanged ranging communications, or to another node in the network. The information can then be communicated to a control system, such as the control system 170 of FIG. 1, to determine how the node can be commissioned. In other embodiments, the determination may be a “cloud based” determination made by one or more components in a network, such as the network 180, for example in a distributed decision process. The information communicated can include information indicative of the node's functionality, such as an inherent attribute, configurable attribute, status attribute, or the like. As described previously herein, the node's functionality can help determine how the node is commissioned in the network (e.g., which nodes it is associated with, how it interacts with those nodes, etc.).

At block 830, commissioning information relating to the node is received. Such commissioning information can include, for example, identification information of one or more other nodes with which the node is associated and/or information to define the node's relationships with the other node(s). For example, a first node having a sensor capable of motion detection may be provided identification information and/or other information for communicating with a second node for controlling a light (and/or other information), enabling the first node to send motion detection information to the second node, providing for motion-based light activation.

At block 840, at least one attribute of the node is configured, based on the commissioning information. This configuration can ensure that the node provides the network with the desired functionality and/or information requested by the network. Continuing with the motion-based light activation example above, the first node with the motion-detection sensor can configure any of a variety of attributes to provide the desired functionality. For example, the network may provide a desired sensitivity level, schedule, duration, etc. for motion detection, and the node can configure corresponding motion-detection attributes accordingly. In other embodiments, the node can configure attributes associated with power supply, ranging capabilities, level of activity, communication properties, and other configurable attributes, such as those described previously, and/or may alter a state based on the commissioning information (e.g., switch from a startup mode to a standby mode). Further, the node may configure a set of other nodes to communicate with or a table including addresses of other nodes to communicate control information with in some embodiments.

As with prior figures, it should be appreciated that the specific steps illustrated in FIG. 8 illustrate an example method for commissioning a node using a network of communicatively-connected components. Alternative embodiments may include alterations to the embodiments shown. Furthermore, additional features may be added or removed depending on the particular applications. For example, the node can additionally or alternatively send sensor and/or control information regarding a status of at least a portion of the structure in which the node is located. One of ordinary skill in the art would recognize many variations, modifications, and alternatives.

FIG. 9 illustrates an embodiment of a computer system 900, which may be incorporated, at least in part, into devices such the control system 170, nodes 150 and 140 of FIGS. 2-3, and/or other components of the social network described herein. FIG. 9 provides a schematic illustration of one embodiment of a computer system 900 that can perform the methods provided by various other embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different physical locations.

The computer system 900 is shown comprising hardware elements that can be electrically coupled via a bus 905 (or may otherwise be in communication, as appropriate). The hardware elements may include a processing unit, such as processor(s) 910, which can include without limitation one or more general-purpose processors, one or more special-purpose processors (such as digital signal processing chips, graphics acceleration processors, and/or the like), and/or other processing structure, which can be configured to perform one or more of the methods described herein, including methods illustrated in FIGS. 6 and 7. The computer system 900 also can include one or more input devices 915, which can include without limitation a mouse, a keyboard, a camera, a microphone, other biometric sensors, and/or the like; and one or more output devices 920, which can include without limitation a display device, a printer, and/or the like.

The computer system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 900 might also include a communications subsystem 930, which can include without limitation a modem, a network card (wireless or wired), an infrared communication device, a wireless communication device, and/or a chipset (such as a Bluetooth™ device, an IEEE 902.11 device, an IEEE 902.15.4 device, a WiFi device, a WiMax device, cellular communication facilities, UWB interface, etc.), and/or the like. The communications subsystem 930 may include one or more input and/or output communication interfaces to permit data to be exchanged with a network (such as the network 180 of FIG. 1), other computer systems, and/or any other electronic devices described herein. Depending on the desired functionality and/or other implementation concerns, a portable electronic device (or similar device) may communicate image and/or other information via the communications subsystem 930. In many embodiments, the computer system 900 will further comprise a working memory 935, which can include a RAM or ROM device, as described above.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above, such as those described in relation to FIGS. 6-7, might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 900) to perform methods in accordance with various embodiments of the invention. According to a set of embodiments, some or all of the procedures of such methods are performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein. Additionally or alternatively, portions of the methods described herein may be executed through specialized hardware.

With reference to the appended figures, components that can include memory, such as data store 160, control system 170, processing unit 210, memory 220, and working memory 935 can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A network comprising a plurality of communicatively-connected components configured for indoor positioning, the network comprising:
a first node having a wireless interface and being disposed at a first location known to the network; and
a second node having a wireless interface and being disposed at a second location known to the network;
wherein:
the first node and the second node are configured to obtain ranging measurements indicating respective distances to a third node; and
one or more elements in the network is configured to:
determine a location of the third node based, at least in part, on the ranging measurements; and
automatically commission the third node by associating the third node with one or more components of the network based, at least in part, on the determined location of the third node.

2. The network of claim 1, wherein the one or more elements in the network is further configured to communicate control information for controlling a status of at least a portion of a structure to the third node.

3. The network of claim 1, wherein the one or more elements in the network is further configured to receive sensor information regarding a status of at least a portion of a structure from the third node.

4. The network of claim 3, wherein the sensor information includes information regarding at least one of lighting, temperature, humidity, movement, occupancy level, or a location associated with an area proximate to the third node.

5. The network of claim 1, wherein the network further comprises a control system.

6. The network of claim 1, wherein the third node is a mobile node.

7. The network of claim 6, wherein the first node and the second node are fixed nodes.

8. The network of claim 6, wherein the network is configured to cause either or both of a distributed control system or a positioning system to generate a message based on the determined location of the mobile node.

9. The network of claim 6, wherein the network is configured to track movement of the mobile node.

10. The network of claim 1, wherein the one or more components to which the third node is associated include one or more of a sensor, a control, an actuator, or a separate node.

11. The network of claim 1, wherein the first node and the second node are configured to obtain the ranging measurements by using at least one of the following ranging operations: received signal strength indicator (RSSI), time of flight (TOF), or round trip time (RTT).

12. The network of claim 1, wherein the network is further configured to cause a status of at least a portion of a structure to be altered, based on the determined location of the third node.

13. The network of claim 12, wherein the status is indicative of at least one of: a power supply, a state of use, a state of one or more controls, a state of one or more interfaces, or one or more sensor readings.

14. The network of claim 1, wherein the first location and the second location are physical locations within a structure.

15. The network of claim 1, further configured to develop a map of a structure based, at least in part, on known locations of at least one of the first node, the second node, or the third node.

16. The network of claim 1, wherein the one or more elements in the network is further configured to automatically commission the third node based on at least one attribute of the third node.

17. The network of claim 16, wherein the at least one attribute is related to at least one of the third node's power supply, mobility, communication type, controllable parameters, sensing capabilities, supported protocols for communication, supported frequency bands, equipment identification number (EIN), ranging capabilities, support of asymmetric ranging operations, product information, or supported configurable parameters.

18. The network of claim 16, wherein the one or more elements is configured to transmit configuration parameters to the third node based on the at least one attribute.

19. A method for commissioning a node using a network of communicatively-connected components, the method comprising:
obtaining ranging measurements from a first node and a second node indicating respective distances to a third node, wherein:
each of the first node, the second node, and the third node use a respective wireless interface to obtain the ranging measurements; and
locations of the first node and the second node are known;
determining a location of the third node based, at least in part, on the ranging measurements; and
automatically commissioning the third node by associating the third node with one or more components of the network based, at least in part, on the determined location of the third node.

20. The method of claim 19, further comprising:
communicating, with at least one of the first node, the second node, or the third node:
sensor information regarding a status of at least a portion of a structure; and
control information for controlling the status of the at least the portion of the structure.

21. The method of claim 19, wherein the third node is a mobile node.

22. The method of claim 21, wherein the first node and the second node are fixed nodes.

23. The method of claim 21, further comprising tracking movement of the mobile node.

24. The method of claim 19, further comprising causing a status of at least a portion of a structure to be altered, based on the determined location of the third node.

25. A system for commissioning a node using a network of communicatively-connected components, the system comprising:
means for obtaining ranging measurements from a first node and a second node indicating respective distances to a third node, wherein:
each of the first node, the second node, and the third node use a respective wireless interface to obtain the ranging measurements; and
locations of the first node and the second node are known;
means for determining a location of the third node based, at least in part, on the ranging measurements; and
means for automatically commissioning the third node by associating the third node with one or more components of the network based, at least in part, on the determined location of the third node.

26. The system of claim 25, further comprising:
means for communicating, with at least one of the first node, the second node, or the third node:
sensor information regarding a status of at least a portion of a structure; and
control information for controlling the status of the at least the portion of the structure.

27. The system of claim 25, wherein the third node is a mobile node.

28. The system of claim 27, wherein the first node and the second node are fixed nodes.

29. The system of claim 27, further comprising means for tracking movement of the mobile node.

30. The system of claim 25, further comprising means for causing a status of at least a portion of a structure to be altered, based on the determined location of the third node.

31. A computer-readable storage medium encoded with instructions that, when executed, operate to cause a computer to perform operations comprising:
receiving ranging measurements from a first node and a second node indicating respective distances to a third node, wherein:
each of the first node, the second node, and the third node use a respective wireless interface to obtain the ranging measurements; and
locations of the first node and the second node are known;
determining a location of the third node based, at least in part, on the ranging measurements; and
automatically commissioning the third node by associating the third node with one or more components of a network based, at least in part, on the determined location of the third node.

32. A method for commissioning a node in an indoor positioning network, the method comprising:
exchanging, using a wireless interface of the node, ranging communications with at least two other nodes for determining a position of the node relative to a structure or map;
sending, using the wireless interface of the node, information regarding the node;
receiving, using the wireless interface of the node, commissioning information relating to the node; and
configuring at least one attribute of the node based on the commissioning information.

33. The method of claim 32, wherein the information regarding the node is indicative of a functionality of the node.

34. The method of claim 32, further comprising sending, using the wireless interface of the node, one or both of:
sensor information regarding a status of at least a portion of the structure; or
control information for controlling the status of the at least the portion of the structure.

35. The method of claim 32, wherein the node is a mobile node, and wherein the commissioning information is based at least in part on the position and the information regarding the node.
